(19) United States
(12) Patent Application Publication
(10) Pub. No.: US 2008/0143091 A1
(43) Pub. Date: Jun. 19, 2008

(54) Load-carrying system for vehicles

(76) Inventor: Katherine Fiedler, Queensland (AU)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/985,238

(22) Filed: Nov. 14, 2007

(30) Foreign Application Priority Data
Nov. 14, 2006 (AU) 2006906351

(51) Int. Cl. B60R 9/00; B60P 1/44; B60P 1/48; B60P 7/02

(52) U.S. Cl. 280/769; 296/100.01; 414/469; 414/495

(57) ABSTRACT

A load-carrying system for vehicles comprises a secondary load support member adapted to be spaced above and extending over at least a portion of the primary load support member. Support means are provided to support the secondary load support member in a first position above the primary load and in a second position where the secondary load support member is moved relative to the primary load to enable access to the primary load or part thereof. The secondary load support member may be hinged to the support means to allow rotation between the first and second positions. Alternatively or additionally, the secondary support member may be moved on tracks between the first position and second position. In one embodiment, the secondary support member may comprise two portions hingedly engaged and rotatable one onto the other. The support means may include telescopic posts and struts, rams or links providing a lifting and/or rotating capacity in movement from the first position to the second position.

### BACKGROUND OF THE INVENTION

1. Field of the Invention

THIS INVENTION relates to a load-carrying system for vehicles.

The invention is particularly suitable for, but not limited to, such a system applicable to vehicles such as utilities, sport utility vehicles (SUV's), small traytop vehicles (with or without drop sides/gates), box trailers and the like.

2. Prior Art

The use of so-called “roof racks” on vehicles to carry loads which cannot otherwise be carried within the vehicles is well-known. While such roof racks increase the effective load-carrying capacity of the vehicles, they have a number of practical limitations, including:

a) they usually require the load to be carried thereon to be loaded and unloaded with raised arms, or for someone to climb up on the vehicle, with the potential for personal injury;

b) the load raises the effective centre of gravity (C.G.) of the loaded vehicle, thereby reducing its stability;

c) the load increases the wind-induced drag of the vehicle, thereby increasing fuel consumption; and

d) it is usually difficult to effectively secure the load to the roof racks.

### SUMMARY OF THE PRESENT INVENTION

It is an object of the present invention to provide a load-carrying system for vehicles, where a secondary (or supplementary) load can be carried above the primary load on the vehicle.

In some embodiments of the present invention there is provided such a system where the secondary load does not extend above the height, or beyond the sides, of the vehicle to minimise any increase in wind drag.

It is a further object of the present invention to provide such a system which enables ready access to the primary load without requiring the secondary load to be unloaded from the vehicle.

It is a still further preferred object to provide a system where additional load(s), eg., ladders, pipes, can be supported on extensions above the secondary load.

In some embodiments of the present invention the load-carrying system can be easily mounted onto, or de-mounted from, the vehicle as required.

Other preferred objects of the present invention will become apparent from the following description.

In a broad aspect, the present invention resides in a load-carrying system for vehicles, to support a secondary (or supplementary) load above a primary load on the vehicle, the system including:

at least one secondary load support member spaced or adapted to be above, and extending over at least a portion of, a primary load support member operable to support the primary load; and

support means to support the at least one secondary load support member in a first position to support the secondary load above the primary load and in a second position where the at least one secondary load support member is moved relative to the primary load support member to enable access to the primary load.

Preferably, the primary load support member is an open-topped compartment, with optional hinged side and/or end wall(s) or gate(s). Examples include a utility body, a tray with a tailgate and/or hinged sides, a box trailer or the like.

Preferably, the secondary load support member has a load-supporting floor and may have hingedly mounted side and/or end walls; and may include at least one hinged cover movable between open and closed positions, eg., for a box-like compartment.

While the load-supporting floor and/or wall(s) may be solid, the secondary load support member may be in the form of a basket, eg., having a perforated floor and/or wall(s).

While the secondary load support member preferably extends substantially over the full area of the primary load support member, it may extend overonly a portion such as one-third or one-half thereof.

The secondary load support member may be hingedly mounted to the support means along, for example, one side or end, or at one corner.

Alternatively, the support means may include a support track assembly to allow the secondary load support member to be moved to the second position preferably extending from one side or end of the primary load support member; or the support means may include a linkage and/or ram system to enable the secondary load support member to be raised above, or to one side or end of the primary load support member.

Preferably, the support means is provided with suitable safety means to secure the secondary load support member in the second position while the primary load is being accessed from the primary load support member. The safety means may include telescopic (eg., hydraulic or pneumatic) struts or links between the primary and secondary load support members.

### BRIEF DESCRIPTION OF THE DRAWINGS

To enable the invention to be fully understood, preferred embodiments will now be described with reference to the accompanying drawings, in which:

FIGS. 1 and 2 are respective side and rear elevational views of a first embodiment of the present invention;

FIGS. 3A and 3B are perspective views of portions of the support means for the first embodiment;

FIG. 4 is a schematic side elevational view of the second embodiment;

FIG. 5 is a similar view of the third embodiment;

FIG. 6A is a sectional side view of a portion of the support means of a fourth embodiment;

FIG. 6B is a schematic top plan view of the fourth embodiment;

FIGS. 7A and 7B are schematic respective top plan and side views of a fifth embodiment;

FIGS. 8A and 8B are schematic side elevational views of a sixth embodiment;

FIGS. 9A and 9B are respective top plan and rear elevational views of a seventh embodiment.

### DETAILED DESCRIPTION OF THE PREFERRED EMBODIMENTS

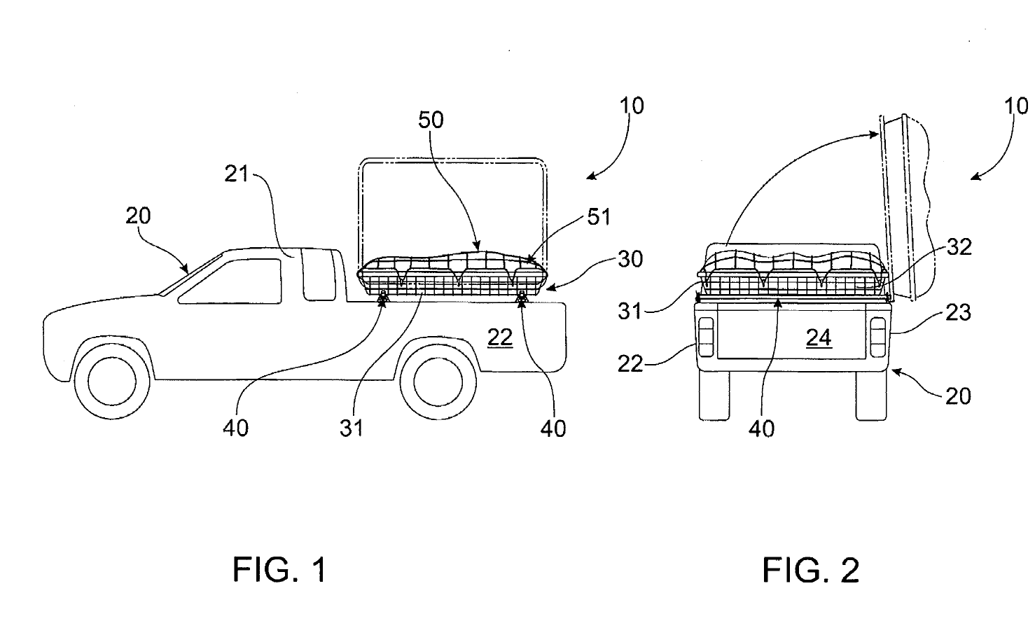

Referring to FIGS. 1, 2, 3A and 3B, the load-carrying system 10 of the first embodiment is designed to be used with a vehicle 20 of the type known in Australia as a “utility” or “dual cab utility” or in the U.S.A. as a “pick-up”, where a primary load (not shown) is carried on a load compartment floor (not shown) defined by the vehicle cab 21, fixed side walls 22, 23 and hinged tailgate 24. While the description is principally directed to these types of vehicles, it is to be understood that the invention may have application to a wider range of vehicle types including trailers, especially box trailers, and trucks. It is generally preferred for the secondary load to be carried below a top line of a carrying or towing vehicle.

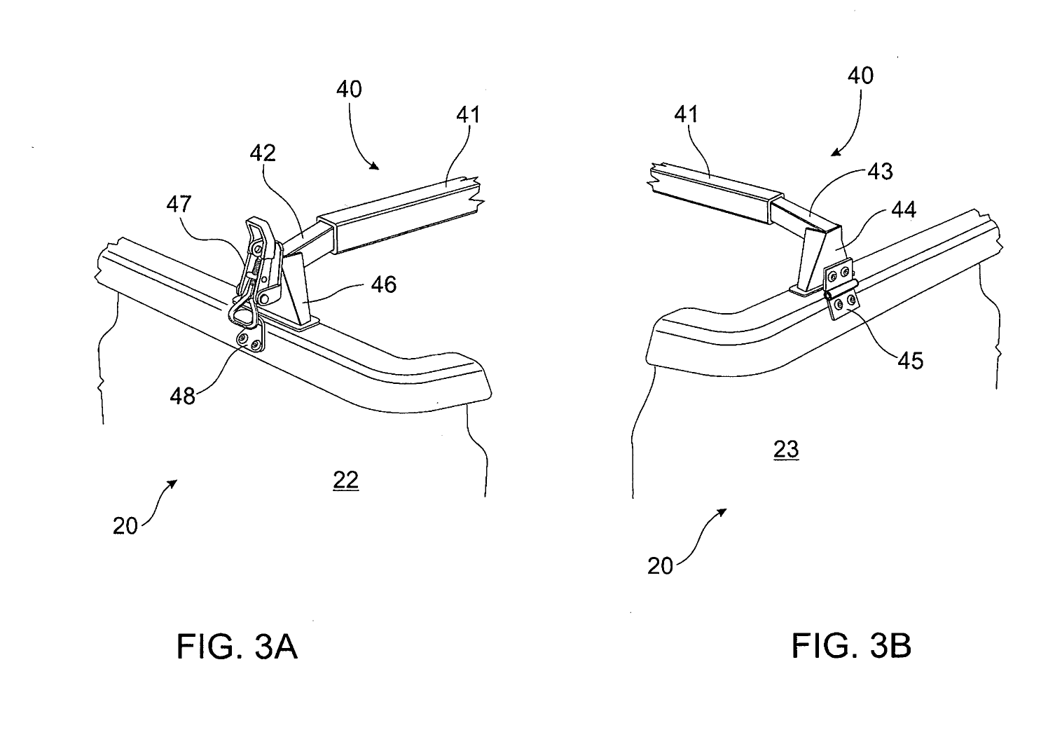

The system 10 has a secondary load support member 30, in the form of a rectangular open-topped basket with a floor (not shown). The side walls 31 and end walls 32 formed of suitable mesh material, eg., metal such as aluminium or steel (which may be coated or have an anti-corrosive protective treatment), plastics (including fibre-reinforced plastics), composite materials, carbon fibre or other suitable materials (or a combination of such materials). The secondary load support member 30 is supported above the load tray (and any primary load carried thereon) by a pair of spaced support means 40 to be described in more detail with reference to FIGS. 3A and 3B.

Each support means 40 has a main (preferably square) tubular beam 41 which receives respective end beams 42, 43.

One of the end beams, 43, is mounted on a post 44 which is hingedly connected to the side walls 23 of the vehicle 20 via a hinge assembly 45.

The second of the end beams, 42, is supported by a similar post 46 which is releasably secured to the other side wall 22 of the vehicle 20 via a latch mechanism 47 which co-operates with a striker hook 48 fixed to the side wall 22. By releasing the latch mechanism 47, the end beam 42 may be released from its support post 46 to allow the main beam 41 to be swung upwardly above a pivotal axis defined by the hinge assembly 45.

As shown in FIGS. 1 and 2, this allows the secondary load support member 30 to be swung from a first position, shown in solid lines, above any primary load supported on the load tray and to a secondary position around a horizontal axis, shown in dashed lines, enabling access to the primary load without removing the secondary load from the secondary load support member.

In this embodiment, the secondary load 50 is releasably secured in the secondary load support member 30 via a cargo net 51 or other suitable restraint means, eg., ropes, cargo straps, so-called “octopus” straps or the like. (If preferred, a tarpaulin or other suitable cover may be placed over the secondary load 50 before the load restraint means are applied.) It could be a rigid cover.

It will be readily apparent to the skilled addressee that the secondary load 50 is supported at a much lower height than if it were supported on roofracks above the vehicle cabin 21, thereby maintaining a lower centre of gravity; the secondary load 50 is below the height of, and behind, the vehicle cabin 21 to minimise any increased wind-induced drag. The secondary load 50 can easily be loaded onto, or unloaded from, the secondary load support member 30; ready access is still available to the primary load when the secondary load 50 is supported by the secondary load support member 30; and the support means 40 can be easily de-mounted (or removed) from the vehicle when the secondary load support member 30 is not required.

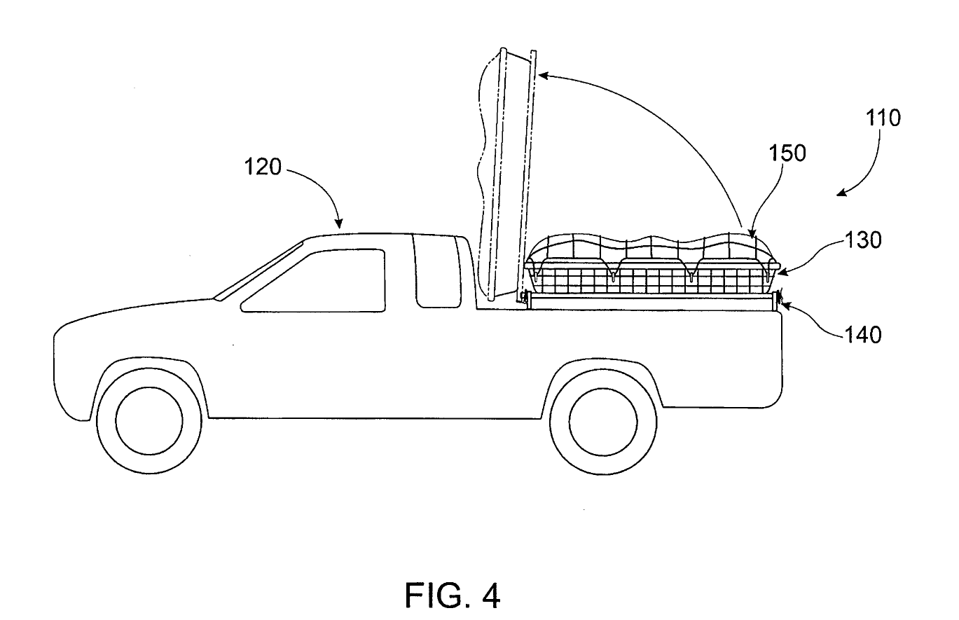

As illustrated in the second embodiment of FIG. 4, the secondary load support member 130 may be hingedly mounted to the support means 140 at its forward end to enable it to be moved between the first and second positions illustrated around a horizontal axis. Once again, the secondary load 150 is readily accessible and does not need to be removed from the secondary load support member 130 to enable access to the primary load.

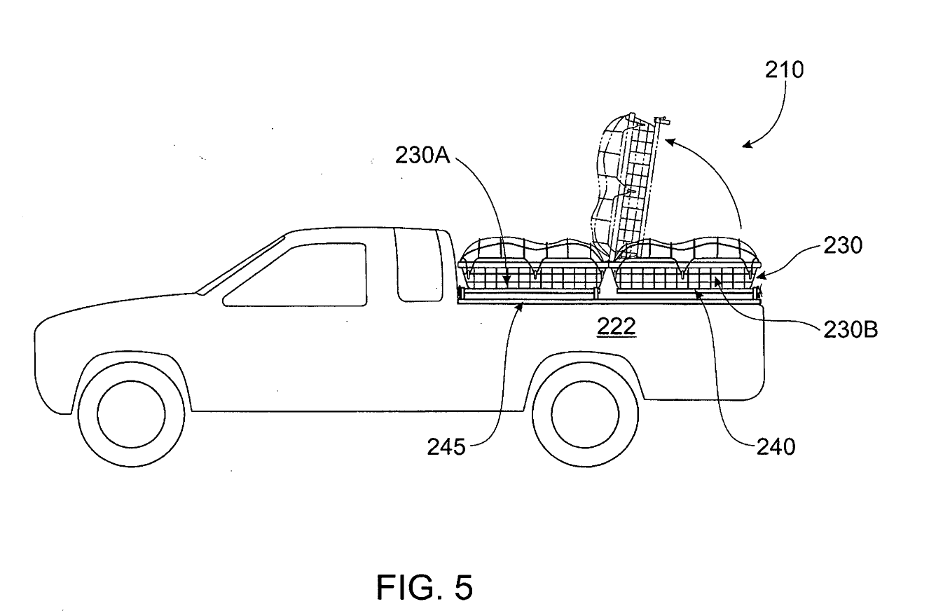

In the third embodiment illustrated in FIG. 5, the load system 210 has the secondary load member 230 separated into a forward portion 230A and a rearward portion 230B, where the rearward portion 230B is hingedly mounted on the forward portion 230A and/or the support means 240 to provide access to the primary load.

In the embodiment shown the support means includes spaced tracks mounted on or adjacent the side walls. In this case, the track 245 is mounted to side wall 222. A corresponding arrangement is provided on the opposite side wall (not shown). In operation, the rearward portion 230B is rotated onto the forward portion 230A and combined forward and rearward portions may be slid along the tracks to allow variable access to the primary load. In an alternative arrangement, the forward portion may be rotated onto the rearward portion. The tracks may be supported on sub-frame legs fixed to, or demountable from, the primary load support. The sub-frame legs may be screwed, clipped, bolted or otherwise releasably connected to the primary load support.

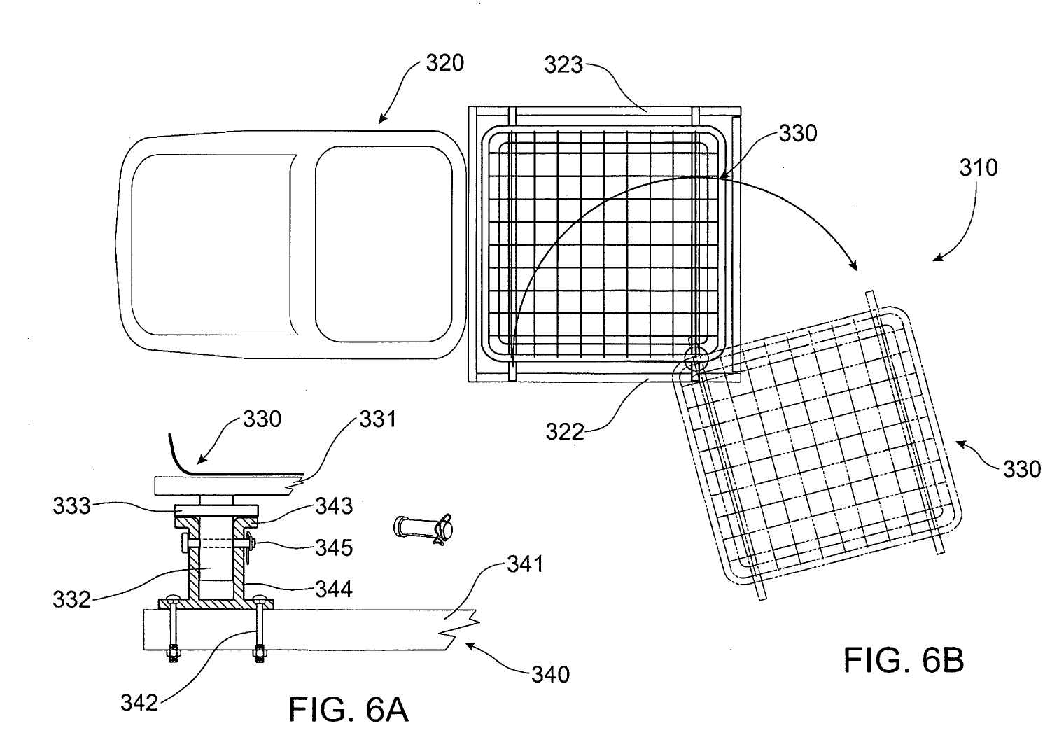

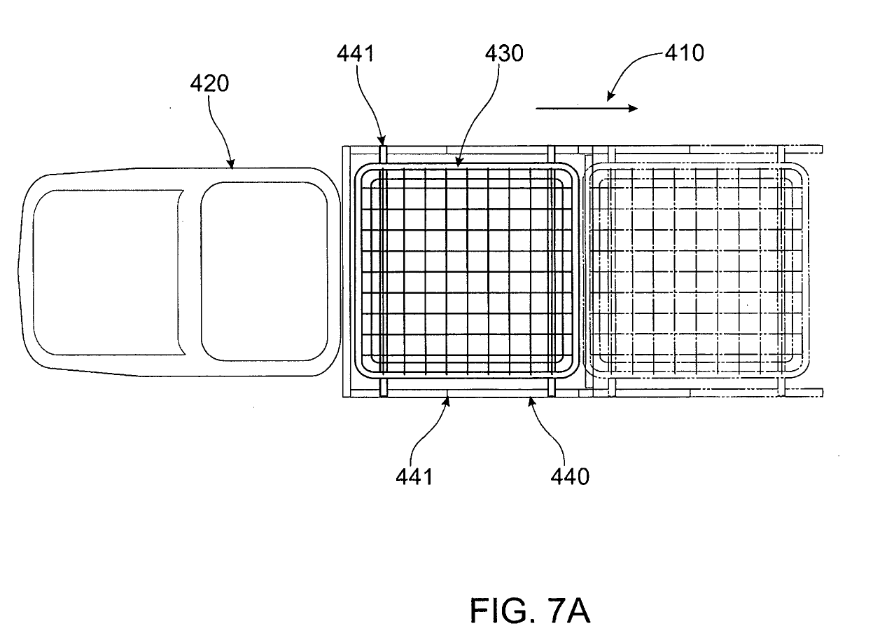

FIGS. 6A and 6B illustrate a fourth embodiment where the secondary load support member 330 of the load system 310 is hingedly mounted at one corner—in this embodiment, the left rear corner—to enable it to be swung to one side of the vehicle 320 around a vertical axis to enable substantially unimpeded access to the primary load (not shown).

The rearward support means 340 has a transverse beam 341 releasably mounted on the side walls 322, 323 of the load compartment of the vehicle 320.

A tubular support post 344 has a base flange secured to the transverse beam 341 by suitable bolts or clamps 342 and has an upper peripheral flange 343 to provide an annular load-bearing surface to be hereinafter described.

The secondary load support member 330 has a support beam 331 with a hinge pin 332 welded or otherwise fixed thereto. The hinge pin 332 has a peripheral flange 333 operable to engage, and be supported by, the load-bearing surface of the peripheral flange 343 of the support post 344, eg., in the manner of a turntable.

A removable locking pin 345 can pass through aligned holes in the support post 344 and the hinge pin 332 to lock the secondary load support member 330 in the first position shown in solid lines in FIG. 6B; or can be removed to enable the second load support member 330 to be swung to the second position shown in dashed lines in FIG. 6B.

In an alternative version, each corner of the secondary load support member 330 may be provided with a pin 332 releasably securable in a respective support post 344, where the secondary load support member 330 can be mounted on, or de-mounted from, the vehicle 320.

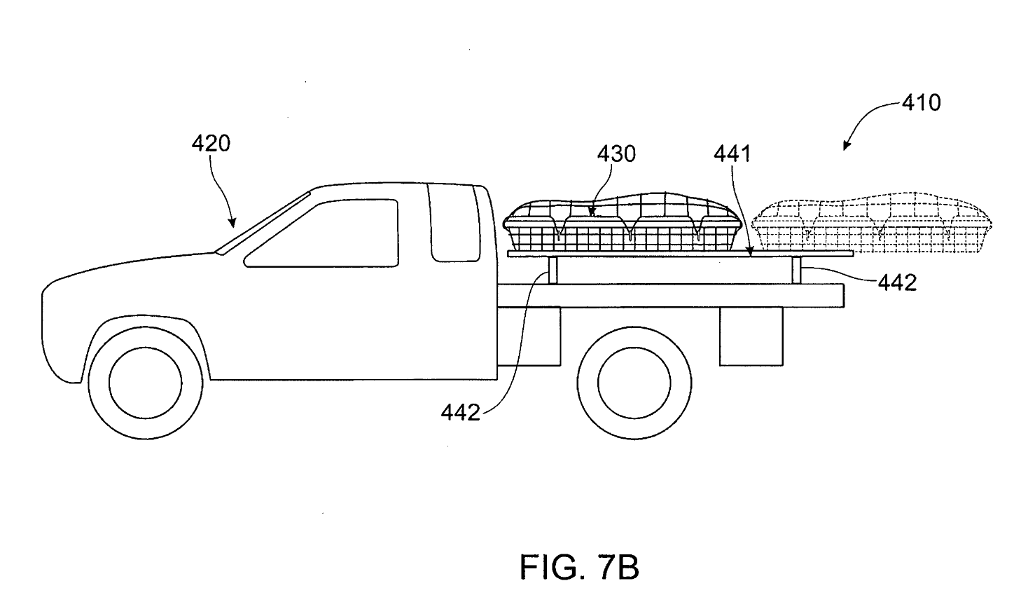

The fifth embodiment illustrated in FIGS. 7A and 7B shows a system 410 where the support means 440 for the secondary support member 430 has parallel tracks 441 mounted on the vehicle 420 to enable the secondary load support member 430 to be moved to a secondary position (shown in dashed lines and in the direction of the arrow) rearwardly of the vehicle 420 in the manner of a drawer.

In an alternative embodiment not shown, a secondary basket may be hingedly connected to a primary basket of the secondary support member 430 and is inverted relative thereto. The secondary basket can be removed if required; can be used to “encapsulate” the secondary load (leaving half the primary load uncovered); or can be swung down to give a full length secondary load support above the primary load.

The parallel tracks 441 can be mounted on sub-frame legs fixed to, or demountable from, the primary load support. The sub-frame legs may be screwed, clipped, bolted or otherwise releasably connected to the primary load support. This is apparent in FIG. 7B where the sub-frame legs 442 support the parallel tracks 441 as shown on a drop side vehicle 420. The secondary load support 430 may be varied in size as required with consequent amendments in the size and strength of components including the attachment to the primary load support member. In a fixed side vehicle, the tracks may be permanently mounted to an upper edge of the side walls; they may even be recessed into the hard sides. Alternatively, the tracks may be demountably fixed to the side walls. In a preferred embodiment, the tracks co-operate with roller bearings, fixed to the bottom of the support member 430 (not shown). Alternatively, the arrangement may include wheels, castors, or a slide block or similar.

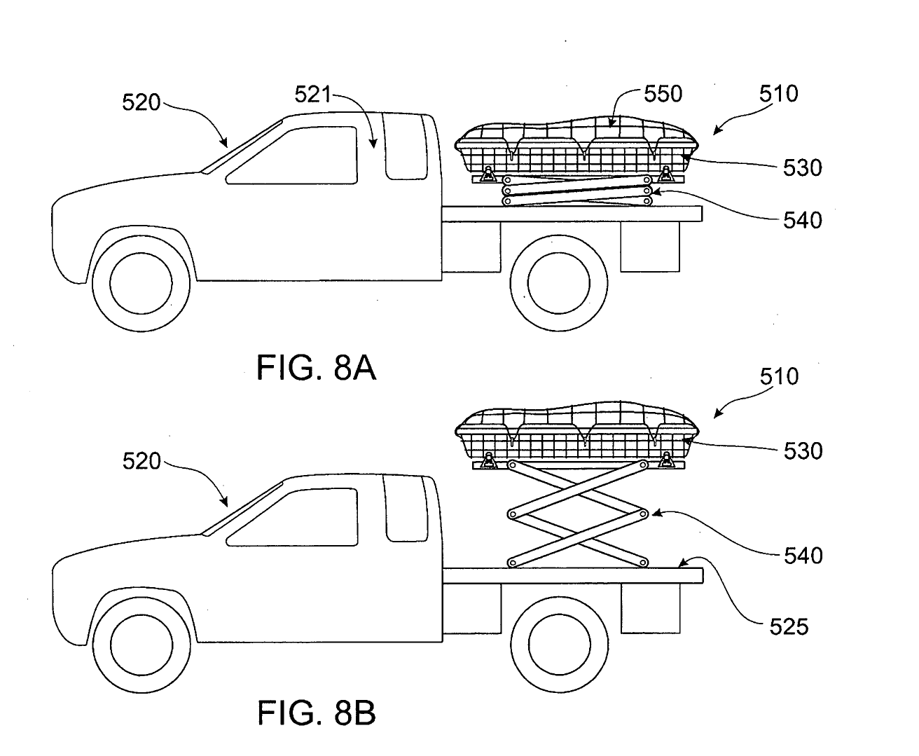

FIGS. 8A and 8B illustrate a sixth embodiment where the load system 510 has the secondary load support member 530 mounted on a scissor-like linkage system providing the support means 540, the support means being supported by the load tray 525 of the vehicle 520 which supports the primary load (not shown).

As with all the previous embodiments, the secondary load 550, when in its first (transport) position—shown in FIG. 8A—remains below the height of the cab 521 to minimise any wind-induced drag and maintain a lower centre of gravity.

In a modified embodiment, not shown, the scissor-like linkage 540 can be rotated through 90°, ie., transverse to the longitudinal axis of the vehicle, to allow side access to the primary load. In certain applications, the operator can elect to extend the secondary load 550 above the height of the cab 521.

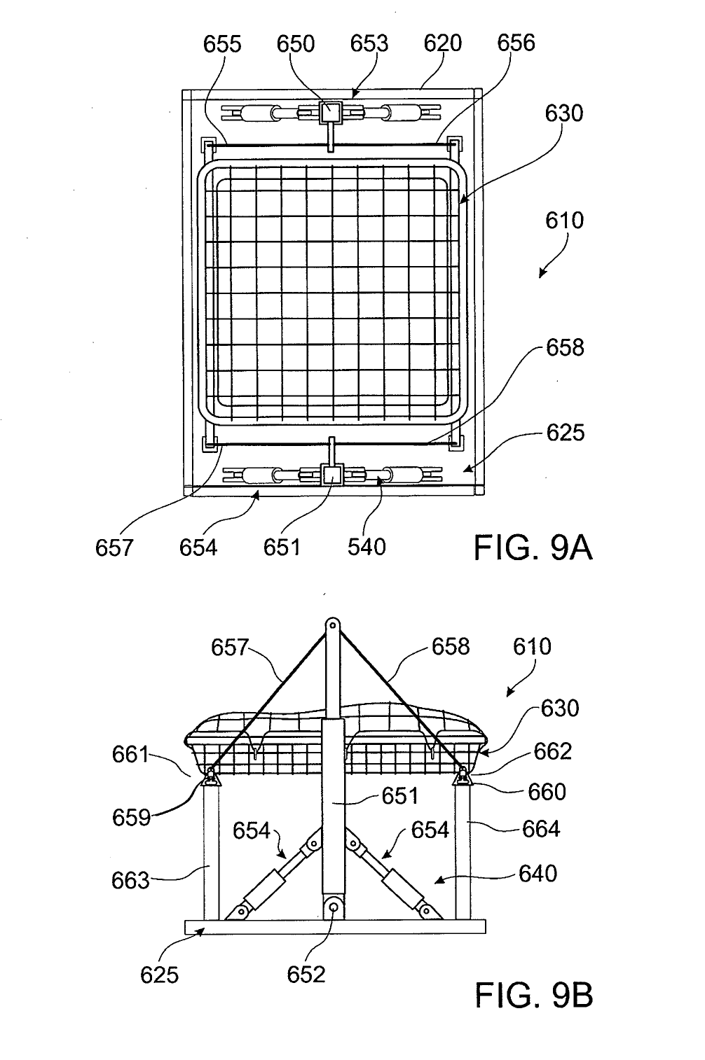

The seventh embodiment illustrated in FIGS. 9A and 9B shows a load system 610 where the support means comprises a ram/linkage system enabling the second load support member 630 to be moved to a secondary position, eg., at ground level, to one side of the load tray 625 of the vehicle 620.

In this case, the support means 640 includes a forward post 650 and rearward post 651. Both posts are pivotally connected to corresponding support brackets of which only rearward support bracket 652 is apparent. This arrangement allows rotation of the posts transverse to a longitudinal axis of the vehicle 620. Each post is linked to a corresponding pair (653, 654 respectively) of co-operating rams. The posts 650, 651 may also be telescopic. The secondary load support member 630 is in turn slung from upper ends of the posts by stays 655, 656, 657, 658.

In the travel position, feet 659, 660 are locked in corresponding channels 661, 662 on support posts 663, 664 at the rearward end and in a similar arrangement forwardly.

To access the primary load, the locked feet are disengaged to allow the secondary load support member (and load) 630 to sit suspended on stays 657, 658. The paired rams 653, 653 are then operated to lift the secondary load support member 630 and extend the posts. This may be sufficient to provide access to the primary load. Additionally or alternatively, differential operation of forward and rearward unilaterally paired rams may allow lateral displacement of the secondary load support member 630 to clear the primary load.

The stays 657, 658 may be variable in length to allow the secondary load support member 630 to be lowered to the ground. Any suitable powered or even hand operated winching system may be suitable in this regard.

In an alternative embodiment, not shown, the hydraulic or pneumatic ram operating the linkage system may be substituted by a winch/cable system, an electric or hydraulic motor or other suitable operating system.

Although not illustrated, vertical extensions can be provided to enable items such as ladders, pipes, electrical conduit or other long loads to be supported above the secondary load. The vertical extension can be mounted on, or demounted from, the primary load supports or the secondary load supports.

The skilled addressee will readily appreciate that other support means can be used to support the secondary load support member above the primary load in its first (transport) position and allow it to be moved to a second position enabling ready access to the primary load supported by the primary load support member.

As hereinbefore described, the secondary load support member may be in the form of an open-topped basket, as illustrated; a load support tray with or without hinged sides and/or end wall(s) or gate(s); a closable box or compartment or other suitable member to support/enclose the secondary load.

Preferably, the carrying system enables the secondary load support member to be de-mounted from the vehicle when not required.

Various changes and modifications may be made to the embodiments described and illustrated without departing from the present invention.

1. A load-carrying system for vehicles to support a secondary load above a primary load on the vehicle, the system including:
at least one secondary load support member spaced above and extending over at least a portion of a primary load support member operable to support the primary load; and
support means to support the at least one secondary load support member in a first position above the primary load and in a second position where the at least one secondary load support member is moved relative to the primary load support member to enable access to the primary load or part thereof.

2. The load-carrying system of claim 1 wherein the primary load support member is an open top compartment with side and/or end walls or gates.

3. The load-carrying system of claim 2 wherein at least one of the side and/or end wall and/or gate is hinged.

4. The load-carrying system of claim 1 wherein the secondary load support member has a load supporting floor and at least one side wall and/or end wall.

5. The load-carrying system of claim 4 wherein at least one of the side or end walls is hingedly mounted.

6. The load-carrying system of claim 5 wherein the secondary load support member includes a hinged cover movable between open and closed positions.

7. The load-carrying system of claim 6 wherein the secondary load support member has a perforated floor and/or walls.

8. The load-carrying system of claim 1 wherein the secondary load support member extends over substantially the full area of the primary load support member or over approximately one third of the primary support member or over approximately one half of the primary support member.

9. The load-carrying system of claim 1 wherein the secondary load support member is hingedly mounted to the support means and is movable from the first position to the second position by rotation.

10. The load-carrying system of claim 9 wherein the secondary load support member is hingedly mounted to one side of the support means and rotates around a horizontal axis.

11. The load-carrying system of claim 9 wherein the secondary load support member is hingedly mounted to one corner of the support means and rotates around a vertical axis.

12. The load-carrying system of claim 1 wherein the support means includes a support track assembly to allow the secondary load support member to be moved between the first position and second position.

13. The load-carrying system of claim 1 wherein the secondary load member comprises a forward portion and a rearward portion hingedly mounted thereto and at least one of the forward portion and rearward portion rotatable onto the other to provide access to the primary load.

14. The load-carrying system of claim 13 wherein the support means further comprises two spaced support tracks to facilitate sliding of the secondary load support member when configured with the forward portion and rearward portion rotated one onto the other.

15. The load-carrying system of claim 1 wherein the support means includes a linkage and/or ram system to enable a secondary load support member to be raised above and/or to one side of the primary load support member.

16. The load-carrying system of claim 1 wherein the support means is provided with suitable safety means to secure the secondary load support member in the second position while the primary load is being accessed from the primary load support member.

17. The load-carrying system of claim 16 wherein the safety means includes telescopic struts, links or rams between the primary and secondary load support members, the telescopic struts, links or rams being hydraulically or pneumatically operated.

18. A load-carrying system for vehicles to support a secondary load above a primary load on the vehicle, the system including:
at least one secondary load support member adapted to be spaced above and extending over at least a portion of a primary load support member operable to support the primary load; and
support means to support the at least one secondary load support member in a first position above the primary load and in a second position where the at least one secondary load support member is moved relative to the primary load support member to enable access to the primary load.
